(19) United States
(12) Patent Application Publication
(10) Pub. No.: US 2023/0000069 A1
(43) Pub. Date: Jan. 5, 2023

(54) TREE STAND

(71) Applicant: Craig R. Cotherman, Redkey, IN (US)

(72) Inventor: Craig R. Cotherman, Redkey, IN (US)

(73) Assignee: Craig R. Cotherman, Redkey, IN (US)

(21) Appl. No.: 17/854,135

(22) Filed: Jun. 30, 2022

Related U.S. Application Data
(60) Provisional application No. 63/217,558, filed on Jul. 1, 2021.

(51) Int. Cl. A01M 31/02; E06C 7/16

(52) U.S. Cl. CPC A01M 31/02; E06C 7/16

(57) ABSTRACT

A ladder tree stand comprises a ladder, a platform carriage multi-pivotably coupled to the ladder, and a platform movably coupled to the platform carriage. A hinge comprises a first post and a male hinge node extending therefrom, and a second post and a female hinge node extending therefrom. The male hinge node and the female hinge node are configured to mate together and to cooperate to pivot relative to each other about a first axis, prevent substantial rotation of the first post relative to the second post about a second axis, and limit a pivotal range of motion between the first post and the second post. A foldable ladder comprises a first runged section, a second runged section, and a hinge pivotally coupling the first runged section to the second runged section.

### CROSS REFERENCE TO RELATED APPLICATION(S)

The present application claims the benefit of priority of U.S. Provisional Patent Application No. 63/217,558, filed Jul. 1, 2021, entitled TREE STAND, the disclosure of which is incorporated herein by reference.

### FIELD OF THE INVENTION

Various embodiments herein pertain to the field of tree stands and, more particularly, to foldable ladder tree stands.

### BACKGROUND

Tree stands have historically comprised rests such as platforms or seats that could be perched on or in trees to provide elevated vantage points for hunters, photographers, and other wildlife enthusiasts. A ladder tree stand (or “ladder-style tree stand,” “ladder stand,” or the like) has historically included a ladder extending from its rest to allow one or more enthusiasts to climb up/down thereto and therefrom.

Some historical ladder tree stands have been undesirably time consuming to set up. Some have comprised undesirably unstable ladders. Some have comprised undesirably immovable and nonadjustable rests.

### SUMMARY OF THE INVENTION

In some embodiments, a ladder tree stand comprises a ladder, a platform carriage multi-pivotably coupled to the ladder, and a platform movably coupled to the platform carriage.

In some embodiments, a ladder tree stand for using a tree to perch above a ground level comprises a rest, a means for elevating the rest above the ground level, and a means for adjustably positioning the rest relative to the means for elevating the rest.

In some embodiments, a hinge comprises a first post, a male hinge node extending from the first post, a second post, and a female hinge node extending from the second post. The male hinge node and the female hinge node are configured to mate together. The male hinge node and the female hinge node are configured to cooperate to pivot relative to each other about a first axis. The male hinge node and the female hinge node are configured to cooperate to prevent substantial rotation of the first post relative to the second post about a second axis. And the male hinge node and the female hinge node are configured to cooperate to limit a pivotal range of motion between the first post and the second post.

In some embodiments, a foldable ladder comprises a first runged section, a second runged section, and a hinge pivotally coupling the first runged section to the second runged section. The hinge comprises a first post, a male hinge node extending from the first post, a second post, and a female hinge node extending from the second post. The male hinge node and the female hinge node are configured to mate together, to cooperate to pivot relative to each other about a first axis, to cooperate to prevent substantial rotation of the first post relative to the second post about a second axis, and to cooperate to limit a pivotal range of motion between the first post and the second post.

It will be appreciated that the various embodiments described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions. Further, the figures shown herein may have been created from scaled drawings, scaled models, or from photographs that are scalable. It is understood that such dimensions, or the relative scaling within a figure, are by way of example, and not to be construed as limiting unless so stated in a claim. Persons of ordinary skill will also recognize that computer-aided design (“CAD”) renderings may include lines that pertain to changes in surface geometry, and not necessarily to component features.

FIG. 1 is a top/ladder-front perspective view of a left-mounted foldable ladder tree stand (unfolded or opened up) in accordance with aspects of the present disclosure.

FIG. 2 is a top/ladder-front perspective view of a right-mounted foldable ladder tree stand (unfolded or opened up) in accordance with aspects of the present disclosure.

FIG. 3 is a front plan view of the left-mounted foldable ladder tree stand (unfolded or opened up) in accordance with aspects of the present disclosure.

FIG. 4 is a front plan view of the right-mounted foldable ladder tree stand (unfolded or opened up) in accordance with aspects of the present disclosure.

FIG. 5 is a top plan view of the right-mounted foldable ladder tree stand (unfolded or opened up) in accordance with aspects of the present disclosure.

FIG. 6 is a right-side plan view of the right-mounted foldable ladder tree stand (unfolded or opened up) in accordance with aspects of the present disclosure.

FIG. 7 is a top/ladder-rear perspective view of the right-mounted foldable ladder tree stand (unfolded or opened up) in accordance with aspects of the present disclosure.

FIG. 8 is a top/ladder-rear perspective view of the top ladder section, platform carriage, and platform of the right-mounted foldable ladder tree stand (unfolded or opened up) in accordance with aspects of the present disclosure.

FIG. 9 is a top plan view of the right-mounted foldable ladder tree stand (platform retracted) in accordance with aspects of the present disclosure.

FIG. 10 is a front plan view of the right-mounted foldable ladder tree stand (platform retracted) in accordance with aspects of the present disclosure.

FIG. 11 is a right-side plan view of the right-mounted foldable ladder tree stand (platform retracted) in accordance with aspects of the present disclosure.

FIG. 12 is a top/ladder-rear perspective view of the right-mounted foldable ladder tree stand (platform retracted) in accordance with aspects of the present disclosure.

FIG. 13 is a top/ladder-rear perspective view of the top ladder section, platform carriage, and platform of the right-mounted foldable ladder tree stand (platform retracted) in accordance with aspects of the present disclosure.

FIG. 14 is a perspective view of the top ladder section, platform carriage, and platform of the right-mounted foldable ladder tree stand in accordance with aspects of the present disclosure.

FIG. 15 is a perspective view of pivot arms in accordance with aspects of the present disclosure.

FIG. 16 are plan views of pivot arms in accordance with aspects of the present disclosure.

FIG. 17 is a rear plan view of the bottom ladder section (support arm extended) in accordance with aspects of the present disclosure.

FIG. 18 is a right-side plan view of the bottom ladder section (support arm extended) in accordance with aspects of the present disclosure.

FIG. 19 is top/ladder-rear perspective view of the bottom ladder section (support arm extended) in accordance with aspects of the present disclosure.

FIG. 20 is a perspective view of the bottom ladder section support arm in accordance with aspects of the present disclosure.

FIG. 21 is a top plan view of the bottom ladder section support arm in accordance with aspects of the present disclosure.

FIG. 22 is a rear plan view of the lower middle ladder section (support arm extended) in accordance with aspects of the present disclosure.

FIG. 23 is a right-side plan view of the lower middle ladder section (support arm extended) in accordance with aspects of the present disclosure.

FIG. 24 is top/ladder-rear perspective view of the lower middle ladder section (support arm extended) in accordance with aspects of the present disclosure.

FIG. 25 is a perspective view of the lower middle ladder section support arm in accordance with aspects of the present disclosure.

FIG. 26 is a top plan view of the lower middle ladder section support arm in accordance with aspects of the present disclosure.

FIG. 27 is a rear plan view of the upper middle ladder section (support arm extended) in accordance with aspects of the present disclosure.

FIG. 28 is a right-side plan view of the upper middle ladder section (support arm extended) in accordance with aspects of the present disclosure.

FIG. 29 is top/ladder-rear perspective view of the upper middle ladder section (support arm extended) in accordance with aspects of the present disclosure.

FIG. 30 is a perspective view of the upper middle ladder section support arm in accordance with aspects of the present disclosure.

FIG. 31 is a top plan view of the upper middle ladder section support arm in accordance with aspects of the present disclosure.

FIG. 32 is a front plan view of the top ladder section in accordance with aspects of the present disclosure.

FIG. 33 is a right-side plan view of the top ladder section in accordance with aspects of the present disclosure.

FIG. 34 is top/ladder-front perspective view of the top ladder section in accordance with aspects of the present disclosure.

FIG. 35 is a perspective exploded view of one of the hinges (with adjoining portions of corresponding ones of the side rails) in accordance with aspects of the present disclosure.

FIG. 36 is a perspective installed view of one of the hinges (hinge open, with adjoining portions of corresponding ones of the side rails) in accordance with aspects of the present disclosure.

FIG. 37 is a perspective installed view of one of the hinges (hinge closed, with adjoining portions of corresponding ones of the side rails) in accordance with aspects of the present disclosure.

FIG. 38 is a perspective view of the female hinge member in accordance with aspects of the present disclosure.

FIG. 39 is a front plan view of the female hinge member in accordance with aspects of the present disclosure.

FIG. 40 is a cross-sectional view of the female hinge member in accordance with aspects of the present disclosure, taken along line 40-40 of FIG. 39.

FIG. 41 is a perspective view of the male hinge member in accordance with aspects of the present disclosure.

FIG. 42 is a front plan view of the male hinge member in accordance with aspects of the present disclosure.

FIG. 43 is a cross-sectional view of the male hinge member in accordance with aspects of the present disclosure, taken along line 43-43 of FIG. 42.

FIG. 44 is a rear plan view of the platform carriage in accordance with aspects of the present disclosure.

FIG. 45 is a left-side plan view of the platform carriage in accordance with aspects of the present disclosure.

FIG. 46 is a top/ladder-front perspective view of the platform carriage in accordance with aspects of the present disclosure.

FIG. 47 is a perspective view of the top ladder section and the rest of the right-mounted foldable ladder tree stand (set up on a tree) in accordance with aspects of the present disclosure.

FIG. 48 is a top plan view of the right-mounted foldable ladder tree stand (folded or closed up) in accordance with aspects of the present disclosure.

FIG. 49 is a front plan view of the right-mounted foldable ladder tree stand (folded or closed up) in accordance with aspects of the present disclosure.

FIG. 50 is a left-side plan view of the right-mounted foldable ladder tree stand (folded or closed up) in accordance with aspects of the present disclosure.

FIG. 51 is a perspective view of the right-mounted foldable ladder tree stand (folded or closed up) in accordance with aspects of the present disclosure.

FIG. 52 is a top perspective view of a support arm bracket in accordance with aspects of the present disclosure.

FIG. 53 is a bottom perspective view of a support arm bracket in accordance with aspects of the present disclosure.

FIG. 54 is a top plan view of a support arm bracket in accordance with aspects of the present disclosure.

### DETAILED DESCRIPTION OF ONE OR MORE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention, and further permits the reasonable and logical inference of still other embodiments as would be understood by persons of ordinary skill in the art.

It is understood that any reference to “the invention” is a reference to an embodiment of a family of inventions, with no single embodiment including an apparatus, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims. The usage of words indicating preference, such as “various embodiments” or “preferably,” refers to features and aspects that are present in at least one embodiment, but which are optional for some embodiments, it therefore being understood that use of the word “preferably” implies the term “optional.”

Like reference numerals refer to like parts throughout the description and the drawings. Additionally, the use of an N-series prefix for an element number (NXX.XX) refers to an element that is the same as the non-prefixed element (XX.XX), except as shown and described. As an example, an element 1020.1 would be the same as element 20.1, except for those different features of element 1020.1 shown and described. Further, common elements and common features of related elements may be drawn in the same manner in different figures, and/or use the same symbology in different figures. As such, it is not necessary to describe the features of 1020.1 and 20.1 that are the same, since these common features are apparent to a person of ordinary skill in the related field of technology. Further, it is understood that some features 1020.1 and 20.1 may be backward compatible, such that a feature of a later discussed embodiment (NXX.XX) may include features compatible with other various embodiments that were discussed earlier (MXX.XX), as would be understood by those of ordinary skill in the art. This description convention also applies to the use of prime (′), double prime (″), triple prime (′″) and star or asterisk (*) suffixed element numbers. Therefore, it is not necessary to describe the features of 20.1, 20.1′, 20.1″, 20.1′″ and 20* that are the same, since these common features are apparent to persons of ordinary skill in the related field of technology.

What follows are paragraphs that express particular embodiments of the present invention. In those paragraphs that follow, some element numbers are prefixed with an “X” indicating that the words pertain to any of the similar features shown in the drawings or described in the text. However, those of ordinary skill in the art will recognize various other non-X prefixed element numbers that discuss features applicable to other embodiments.

This document may use different words to describe the same element number, or to refer to an element number in a specific family of features (NXX.XX) It is understood that such multiple, different words are not intended to provide a redefinition of any language herein. It is understood that such words demonstrate that the particular feature can be considered in various linguistical ways, such ways not necessarily being additive or exclusive.

As used in this description and/or the claims, the term “runged” means having one or more rungs.

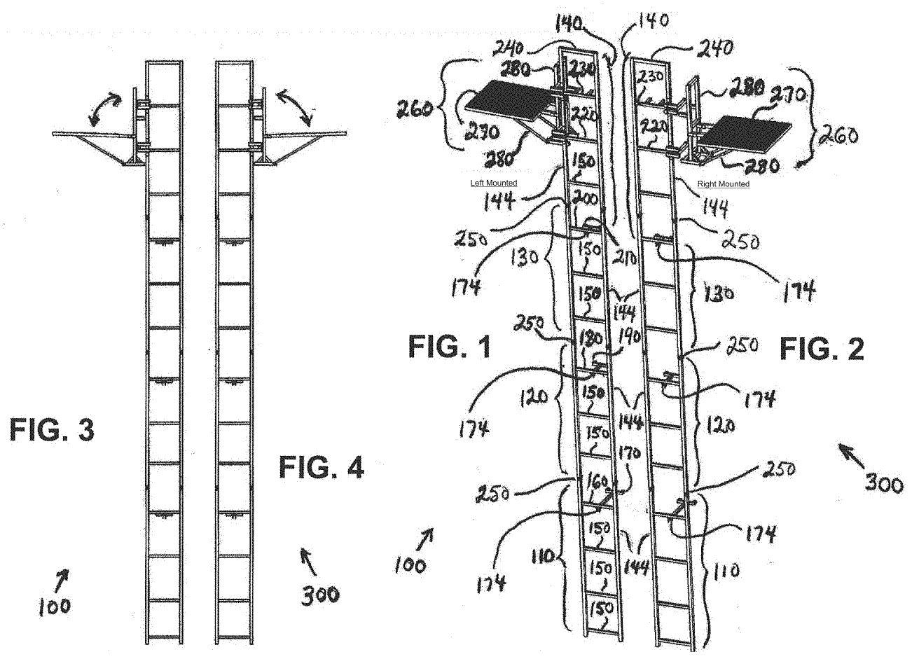

FIG. 1 is a top/ladder-front perspective view of a left-mounted foldable ladder tree stand 100 (unfolded or opened up) in accordance with aspects of the present disclosure. In various embodiments, components of the tree stand 100 may (unless otherwise expressly stated) be made of suitable aluminum, steel, fiberglass, and/or any other material(s) suitable for the construction of portable ladders.

The tree stand 100 comprises a bottom ladder assembly or bottom ladder section 110, a lower middle ladder assembly or lower middle ladder section 120, an upper middle ladder assembly or upper middle ladder section 130, and a top ladder assembly or top ladder section 140. Each ladder section 110, ladder section 120, ladder section 130, and ladder section 140 comprises a pair of substantially similar, suitably laterally-spaced-apart substantially rectilinear hollow side rails 144 and one or more of a plurality of substantially similar, suitably spaced-apart rungs 150.

The ladder section 110 further comprises a top rung 160, a substantially rectilinear support arm 170, and one of a plurality of support arm brackets 174. The one of the brackets 174 pivotally attaches the support arm 170 to the rung 160. The ladder section 120 further comprises a top rung 180, a substantially rectilinear support arm 190, and one of the brackets 174. The one of the brackets 174 pivotally attaches the support arm 190 to the rung 180. The ladder section 130 further comprises a top rung 200, a substantially rectilinear support arm 210, and one of the brackets 174. The one of the brackets 174 pivotally attaches the support arm 210 to the rung 200. The ladder section 140 further comprises a rung 220, a rung 230, and a cap or top bar 240.

The tree stand 100 further comprises a plurality of substantially identical hinges 250. One of the hinges 250 pivotally couples one of the rails 144 of the ladder section 110 (e.g., the left rail of the ladder section 110) to the corresponding rail of the ladder section 120 (e.g., to the left rail of the ladder section 120). One of the hinges 250 pivotally couples the other of the rails 144 of the ladder section 110 (e.g., the right rail of the ladder section 110) to the corresponding rail of the ladder section 120 (e.g., to the right rail of the ladder section 120). One of the hinges 250 pivotally couples one of the rails 144 of the ladder section 120 to the corresponding rail of the ladder section 130. One of the hinges 250 pivotally couples the other of the rails 144 of the ladder section 120 to the corresponding rail of the ladder section 130. One of the hinges 250 pivotally couples one of the rails 144 of the ladder section 130 to the corresponding rail of the ladder section 140. One of the hinges 250 pivotally couples the other of the rails 144 of the ladder section 130 to the corresponding rail of the ladder section 140.

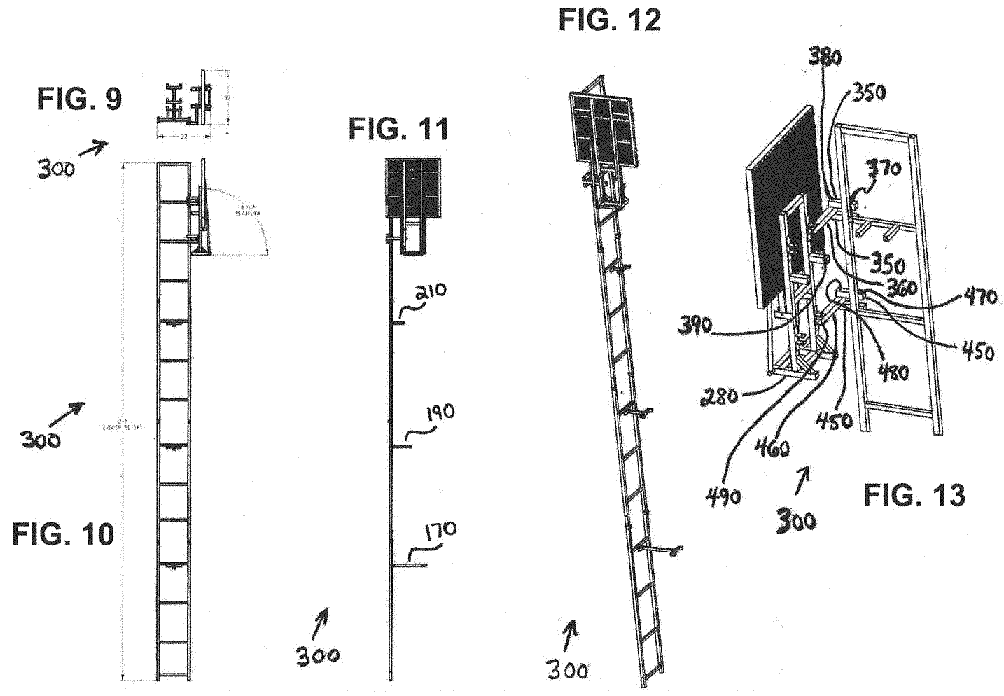

The tree stand 100 further comprises a rest 260. The rest 260 comprises a platform 270 and a platform frame assembly or platform carriage 280. The platform 270 is movably coupled to the platform carriage 280 such that the platform 270 is movable between an unfolded or opened position (depicted in FIGS. 1-8) and a folded or closed position (depicted in FIGS. 9-13). Additionally, the platform carriage 280 is multi-pivotally coupled (described further below) to the left one of the rails 144 of the top ladder section 140. The platform 270 and the platform carriage 280 are configured to support at least one standing, sitting, or laying person (not shown) with the platform unfolded. In various other embodiments, the rest 260 may comprise a covered or uncovered floor or other platform, shelter, hunting or photography blind, or any other structure suitable for supporting the weight of and providing a vantage point to a typical hunter, photographer, or other wildlife enthusiast. In some embodiments, the rest 260 may support up to 3501bs. In some embodiments, the rest 260 may support up to 7001bs or more. It should be noted that in some embodiments, the rest 260 is configured to be separable from the top ladder section 140.

FIG. 2 is a top/ladder-front perspective view of a right-mounted foldable ladder tree stand 300 (unfolded or opened up) in accordance with aspects of the present disclosure. While it should be appreciated that the tree stand 300 differs from the tree stand 100 only in that in the tree stand 300 the rest 260 is coupled to the right one of the rails 144 of the top ladder section 140 rather than the left one of the rails 144. It should also be appreciated that with respect to some embodiments this versatility or ready reconfigurability to provide either a left-mounted or a right-mounted rest 260 may at times be quite advantageous.

FIG. 3 is a front plan view of the left-mounted foldable ladder tree stand 100 (unfolded or opened up) in accordance with aspects of the present disclosure.

FIG. 4 is a front plan view of the right-mounted foldable ladder tree stand 300 (unfolded or opened up) in accordance with aspects of the present disclosure.

FIG. 5 is a top plan view of the right-mounted foldable ladder tree stand 300 (unfolded or opened up) in accordance with aspects of the present disclosure.

FIG. 6 is a right-side plan view of the right-mounted foldable ladder tree stand 300 (unfolded or opened up) in accordance with aspects of the present disclosure.

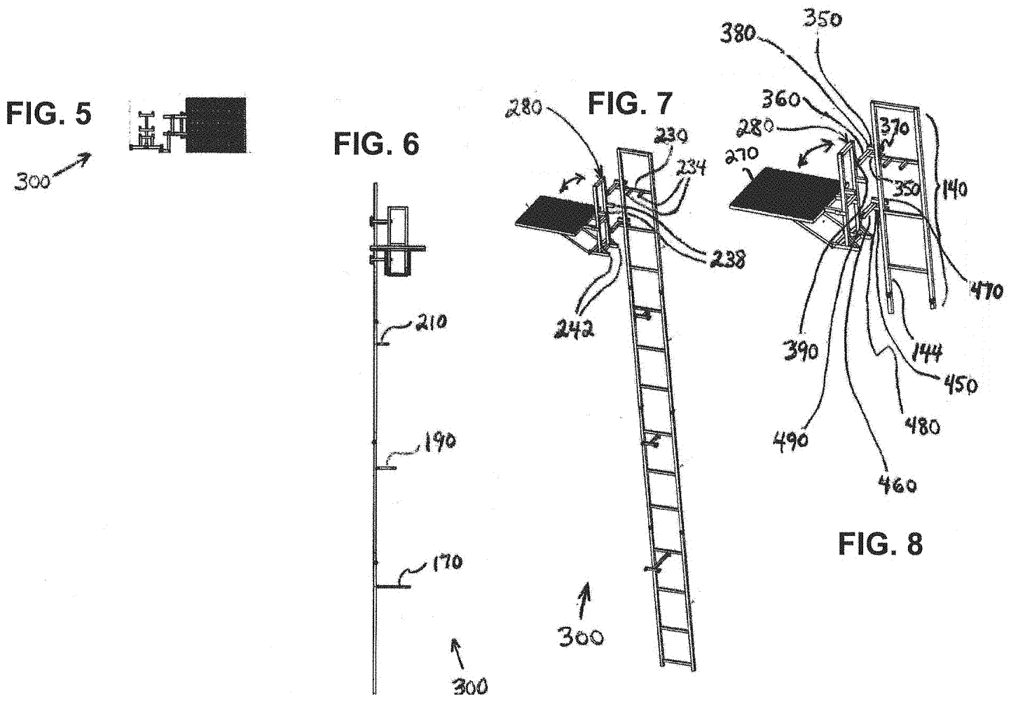

FIG. 7 is a top/ladder-rear perspective view of the right-mounted foldable ladder tree stand 300 (unfolded or opened up) in accordance with aspects of the present disclosure. As illustrated in FIG. 7, the top ladder section 140 also comprises a pair of substantially similar, laterally-spaced-apart substantially rectilinear hollow support posts 234 protruding from the rung 230, the platform carriage 280 comprises a pair of protruding substantially similar, laterally-spaced-apart substantially rectilinear hollow support posts 238, and the platform carriage 280 comprises a pair of somewhat protruding substantially similar, laterally-spaced-apart substantially rectilinear hollow lower support rails 242.

FIG. 8 is a top/ladder-rear perspective view of the top ladder section 140, platform carriage 280, and platform 270 of the right-mounted foldable ladder tree stand 300 (unfolded or opened up) in accordance with aspects of the present disclosure. As illustrated in FIG. 8, the top ladder section 140 also comprises a pair of spaced apart short upper platform carriage pivot arms 350 having respective first ends and second ends, the top ladder section 140 also comprises a long upper platform carriage pivot arm 360 having a first end and a second end, the top ladder section 140 also comprises a first upper platform carriage pivot joint 370 pivotally coupling the first ends of the short upper platform carriage pivot arms 350 to the right one of the rails 144 of the top ladder section 140, the top ladder section 140 also comprises a second upper platform carriage pivot joint 380 pivotally coupling the first end of the long upper platform carriage pivot arm 360 to and between the second ends of the short upper platform carriage pivot arms 350, the top ladder section 140 also comprises a third upper platform carriage pivot joint 390 pivotally coupling the second end of the long upper platform carriage pivot arm 360 to the platform carriage 280, the top ladder section 140 also comprises a pair of spaced apart short lower platform carriage pivot arms 450 having respective first ends and second ends, the top ladder section 140 also comprises a long lower platform carriage pivot arm 460 having a first end and a second end, the top ladder section 140 also comprises a first lower platform carriage pivot joint 470 pivotally coupling the first ends of the short lower platform carriage pivot arms 450 to the right one of the rails 144 of the top ladder section 140, the top ladder section 140 also comprises a second lower platform carriage pivot joint 480 pivotally coupling the first end of the long lower platform carriage pivot arm 460 to and between the second ends of the short lower platform carriage pivot arms 450, and the top ladder section 140 also comprises a third lower platform carriage pivot joint 490 pivotally coupling the second end of the long lower platform carriage pivot arm 460 to the platform carriage 280. It should be appreciated, then, that the platform carriage 280 is multi-pivotally coupled (i.e., coupled via an arrangement, assembly, mechanism, or the like comprising at least two pivot joints) to the left one of the rails 144 of the top ladder section 140. It should also be appreciated that, more broadly speaking, the platform carriage 280 is also multi-pivotably coupled (i.e., coupled via an arrangement, assembly, mechanism, or the like comprising at least two pivotable joints) to the left one of the rails 144 of the top ladder section 140. In some embodiments, one or more of the pivot joints 370, 380, 390, 470, 480, and 490 may be replaced with one or more suitable ball-and-socket type joints or any other suitable pivotable joints.

FIG. 9 is a top plan view of the right-mounted foldable ladder tree stand 300 (platform 270 folded or closed up) in accordance with aspects of the present disclosure.

FIG. 10 is a front plan view of the right-mounted foldable ladder tree stand 300 (platform 270 folded or closed up) in accordance with aspects of the present disclosure.

FIG. 11 is a right-side plan view of the right-mounted foldable ladder tree stand 300 (platform 270 folded or close up) in accordance with aspects of the present disclosure.

FIG. 12 is a top/ladder-rear perspective view of the right-mounted foldable ladder tree stand 300 (platform 270 folded or closed up) in accordance with aspects of the present disclosure.

FIG. 13 is a top/ladder-rear perspective view of the top ladder section 140, platform carriage 280, and platform 270 of the right-mounted foldable ladder tree stand 300 (platform 270 folded or closed up) in accordance with aspects of the present disclosure.

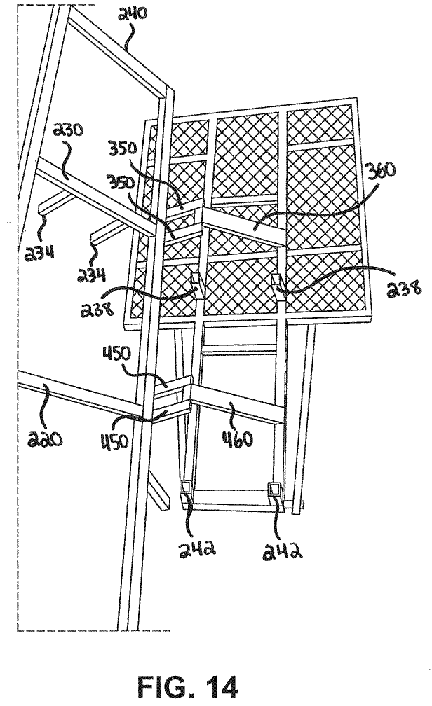

FIG. 14 is a perspective view of the top ladder section 140, platform carriage 280, and platform 270 of the right-mounted foldable ladder tree stand 300 in accordance with aspects of the present disclosure.

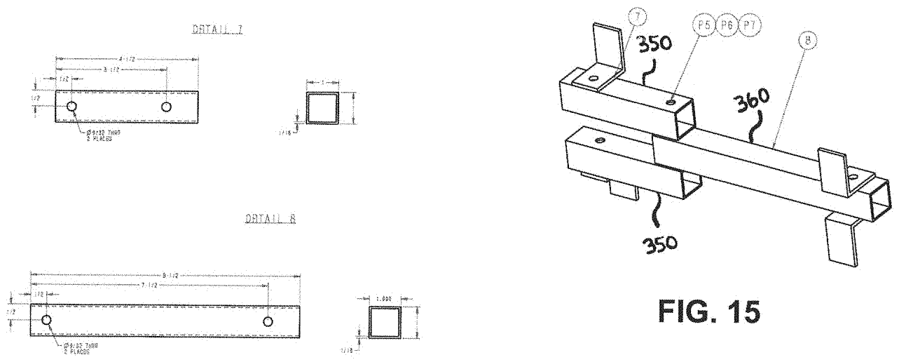

FIG. 15 is a perspective view of pivot arms 350 and pivot arm 360 in accordance with aspects of the present disclosure.

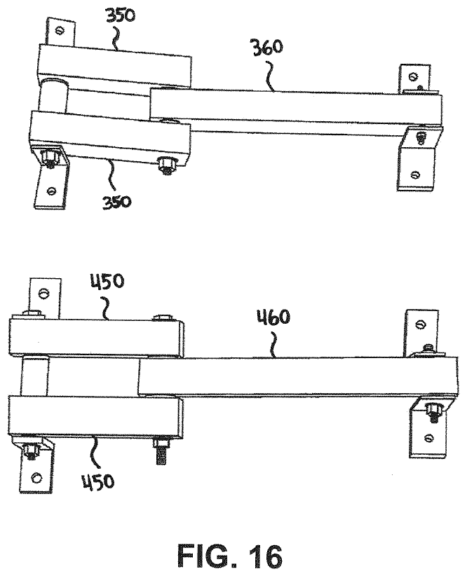

FIG. 16 are plan views of pivot arms 350, pivot arm 360, pivot arms 450, and pivot arm 460 in accordance with aspects of the present disclosure.

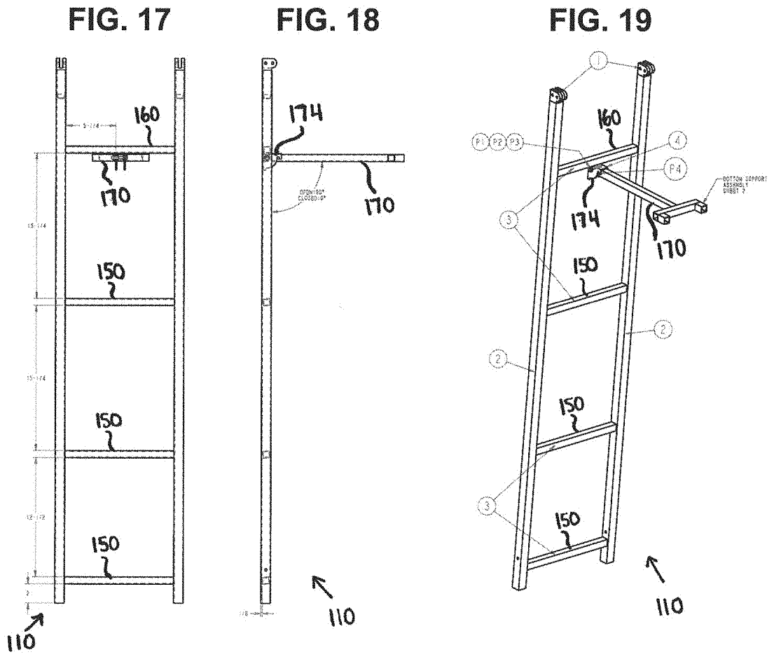

FIG. 17 is a rear plan view of the bottom ladder section 110 (support arm 170 extended) in accordance with aspects of the present disclosure.

FIG. 18 is a right-side plan view of the bottom ladder section 110 (support arm 170 extended) in accordance with aspects of the present disclosure.

FIG. 19 is top/ladder-rear perspective view of the bottom ladder section 110 (support arm 170 extended) in accordance with aspects of the present disclosure.

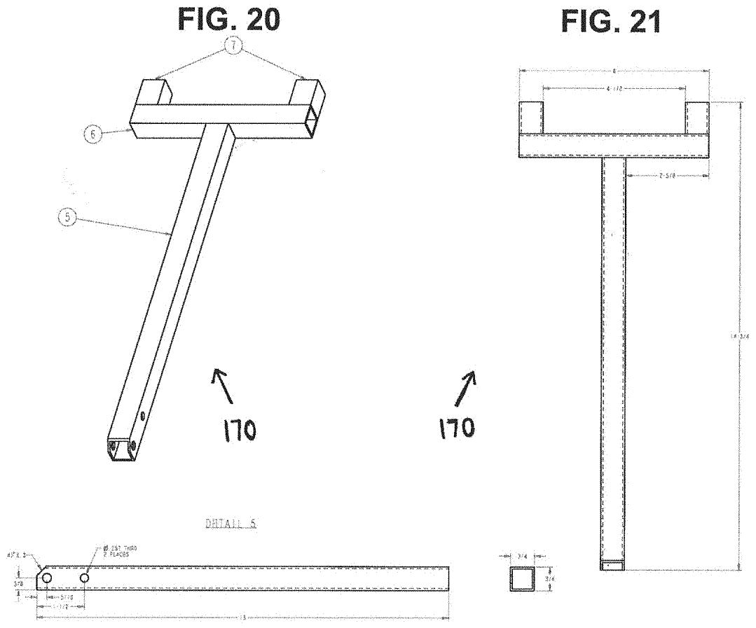

FIG. 20 is a perspective view of the bottom ladder section support arm 170 in accordance with aspects of the present disclosure.

FIG. 21 is a top plan view of the bottom ladder section support arm 170 in accordance with aspects of the present disclosure.

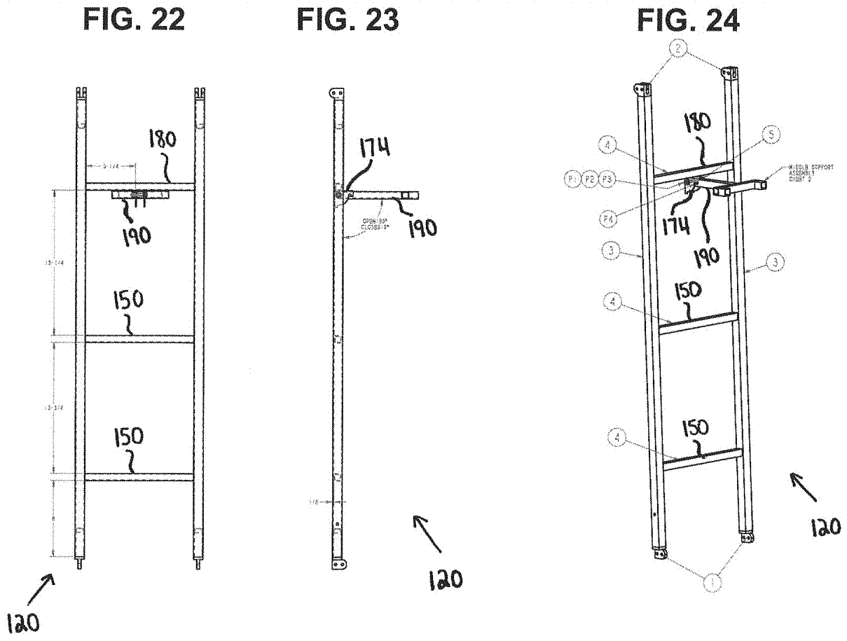

FIG. 22 is a rear plan view of the lower middle ladder section 120 (support arm 190 extended) in accordance with aspects of the present disclosure.

FIG. 23 is a right-side plan view of the lower middle ladder section 120 (support arm 190 extended) in accordance with aspects of the present disclosure.

FIG. 24 is top/ladder-rear perspective view of the lower middle ladder section 120 (support arm 190 extended) in accordance with aspects of the present disclosure.

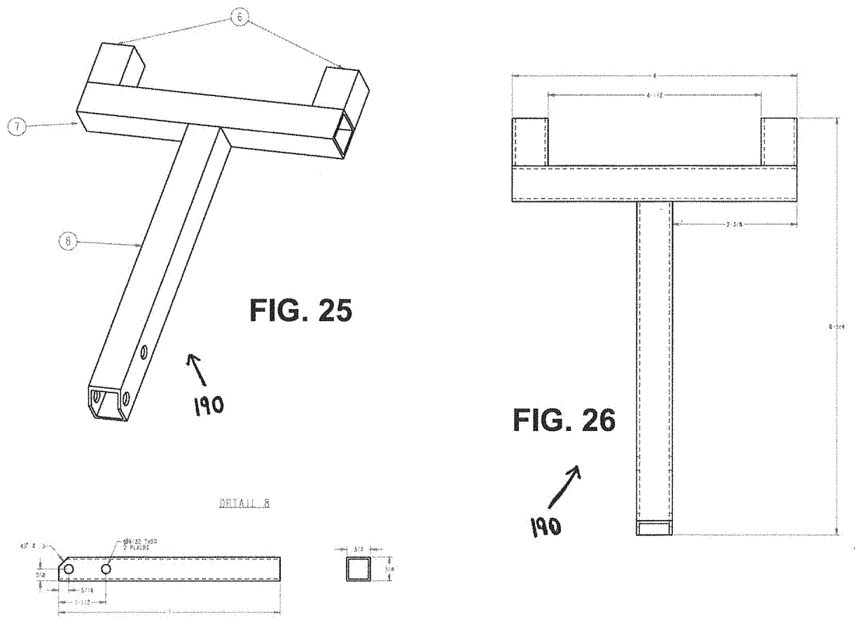

FIG. 25 is a perspective view of the lower middle ladder section support arm 190 in accordance with aspects of the present disclosure.

FIG. 26 is a top plan view of the lower middle ladder section support arm 190 in accordance with aspects of the present disclosure.

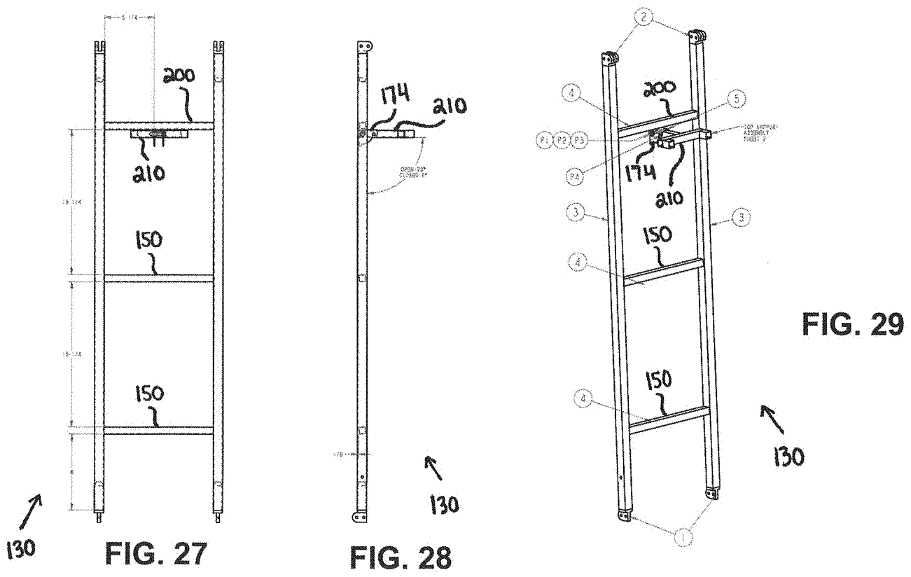

FIG. 27 is a rear plan view of the upper middle ladder section 130 (support arm 210 extended) in accordance with aspects of the present disclosure.

FIG. 28 is a right-side plan view of the upper middle ladder section 130 (support arm 210 extended) in accordance with aspects of the present disclosure.

FIG. 29 is top/ladder-rear perspective view of the upper middle ladder section 130 (support arm 210 extended) in accordance with aspects of the present disclosure.

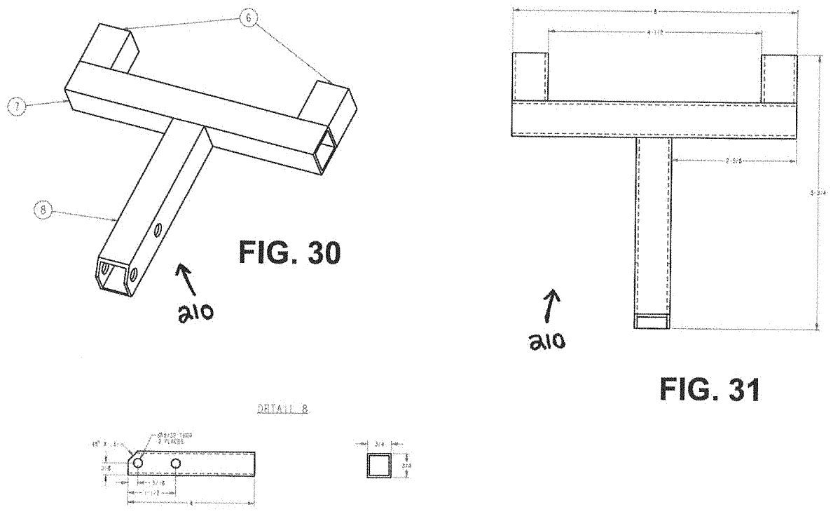

FIG. 30 is a perspective view of the upper middle ladder section support arm 210 in accordance with aspects of the present disclosure.

FIG. 31 is a top plan view of the upper middle ladder section support arm 210 in accordance with aspects of the present disclosure.

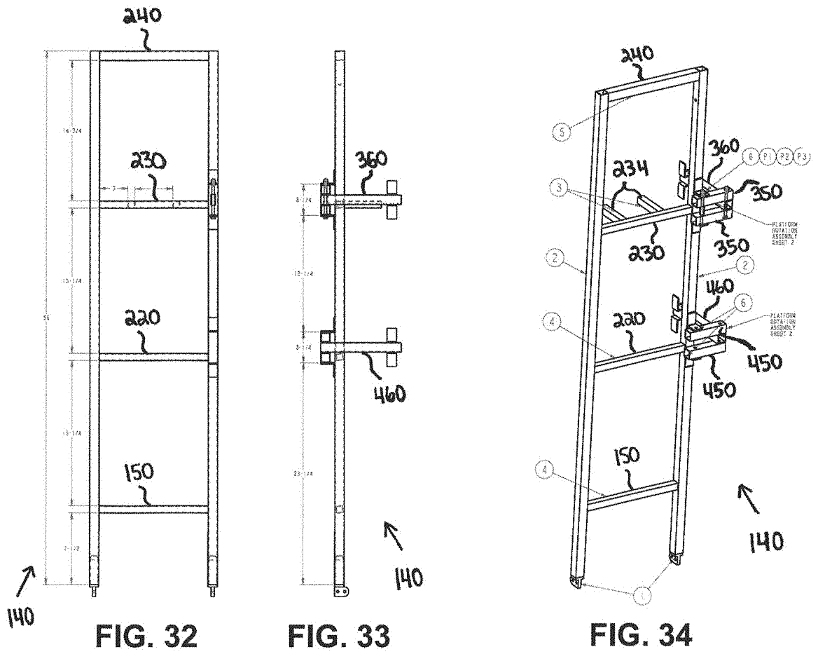

FIG. 32 is a front plan view of the top ladder section 140 in accordance with aspects of the present disclosure.

FIG. 33 is a right-side plan view of the top ladder section 140 in accordance with aspects of the present disclosure.

FIG. 34 is top/ladder-front perspective view of the top ladder section 140 in accordance with aspects of the present disclosure.

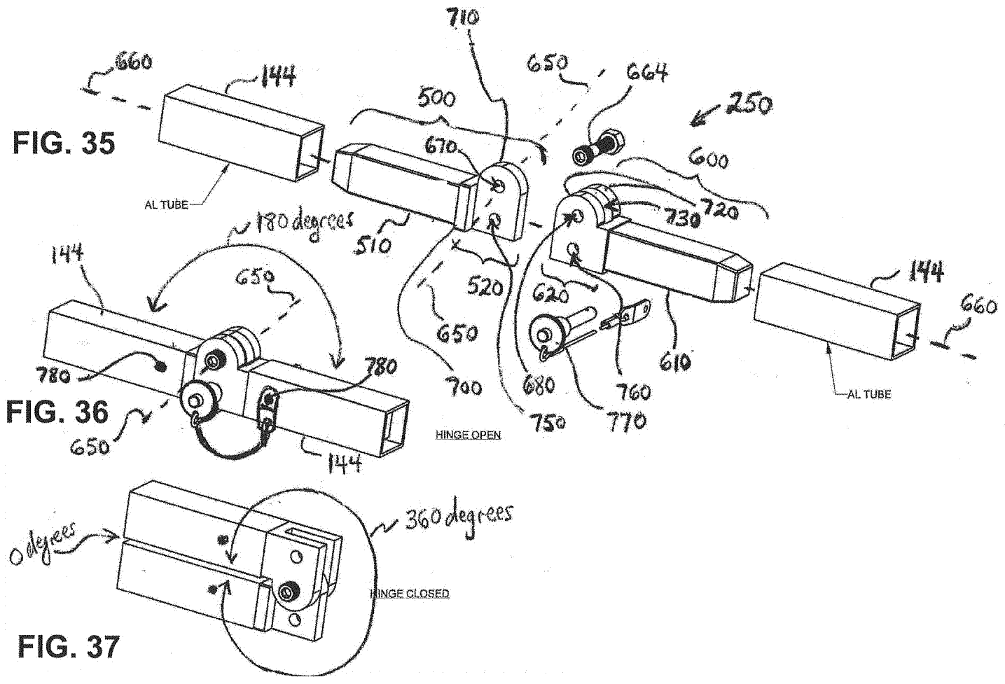

FIG. 35 is a perspective exploded view of one of the hinges 250 (with adjoining portions of corresponding ones of the side rails 144) in accordance with aspects of the present disclosure. Each one of the hinges 250 comprises a male hinge member 500. The male hinge member 500 comprises a post 510 and a male hinge node 520 extending from the post 510. Each one of the hinges 250 also comprises a female hinge member 600. The female hinge member 600 comprises a post 610 and a female hinge node 620 extending from the post 610. The male hinge node 520 and the female hinge node 620 are configured to mate together. The male hinge node 520 and the female hinge node 620 are configured to cooperate to pivot relative to each other about an axis 650. The male hinge node 520 and the female hinge node 620 are configured to cooperate to prevent substantial rotation of the post 510 relative to the post 610 about an axis 660. The male hinge node 520 and the female hinge node 620 are configured to cooperate to limit a pivotal range of motion between the post 510 and the post 610.

Each of the hinges 250 also comprises an axle bolt 664 extending through an aperture 670 of the male hinge node 520 and extending through a corresponding pair of apertures 680 of the female hinge node 620. It should be appreciated that in some embodiments, the axle bolt 664 may be replaced with a rivet or any other suitable axle member.

The male hinge node 520 comprises a generally rectilinear flange 700 configured to abut a portion of the female hinge node 620 so as to stop or limit a pivotal travel or range of motion between the male hinge node 520 (and, thus, the post 510) and the female hinge node 620 (and, thus, the post 610). The male hinge node 520 also comprises a protuberance 710 extending from the flange 700. The protuberance 710 defines the aperture 670.

The female hinge node 620 comprises a pair of protuberances 720. The protuberances 720 are spaced apart so as to define a slot 730 between them. Additionally, each of the protuberances 720 defines a respective one of the apertures 680. The protuberance 710 extends into the slot 730. And the axle bolt 664 extends through a first one of the apertures 680, though the aperture 670, and through the other one of the apertures 680.

The protuberance 710 also defines an additional aperture 750 extending therethrough. And the protuberances 720 each define one of a corresponding additional respective pair of apertures 760 extending therethrough. The male hinge node 520 and the female hinge node 620 are configured such that when the hinge 250 is fully opened (such that the corresponding ones of the side rails 144 are about 180 degrees apart) the aperture 750 axially aligns with the apertures 760, thereby allowing insertion of a spring-loaded retention pin 770 or other suitable shaft member through one of the apertures 760, through the aperture 750, and through the other one of the apertures 760 so as to lock the hinge 250 in an opened position.

In the illustrated embodiment the post 510, the post 610, and the side rails 144 are sized for a suitably secure compression fit of the post 510 and the post 610 within the respective ones of the side rails 144. Additionally, one or more nails, compression-fitted pegs, or screws 780 (not illustrated in FIG. 35, but see FIG. 36) may be hammered or drilled through each one of the side rails 144 and the respective one of the post 510 and post 610 to further secure each of the hinges 250 to the corresponding ones of the side rails 144. It should be appreciated that although the post 510 and the post 610 are illustrated as substantially rectilinear (so as to substantially match the interiors of the corresponding respective ones of the side rails 144), in some embodiments the post 510, the post 610, and/or the siderails 144 may be generally cylindrical or have other suitable geometries.

FIG. 36 is a perspective installed view of one of the hinges 250 (hinge 250 open, with adjoining portions of corresponding ones of the side rails 144) in accordance with aspects of the present disclosure.

FIG. 37 is a perspective installed view of one of the hinges 250 (hinge 250 closed, with adjoining portions of corresponding ones of the side rails 144) in accordance with aspects of the present disclosure.

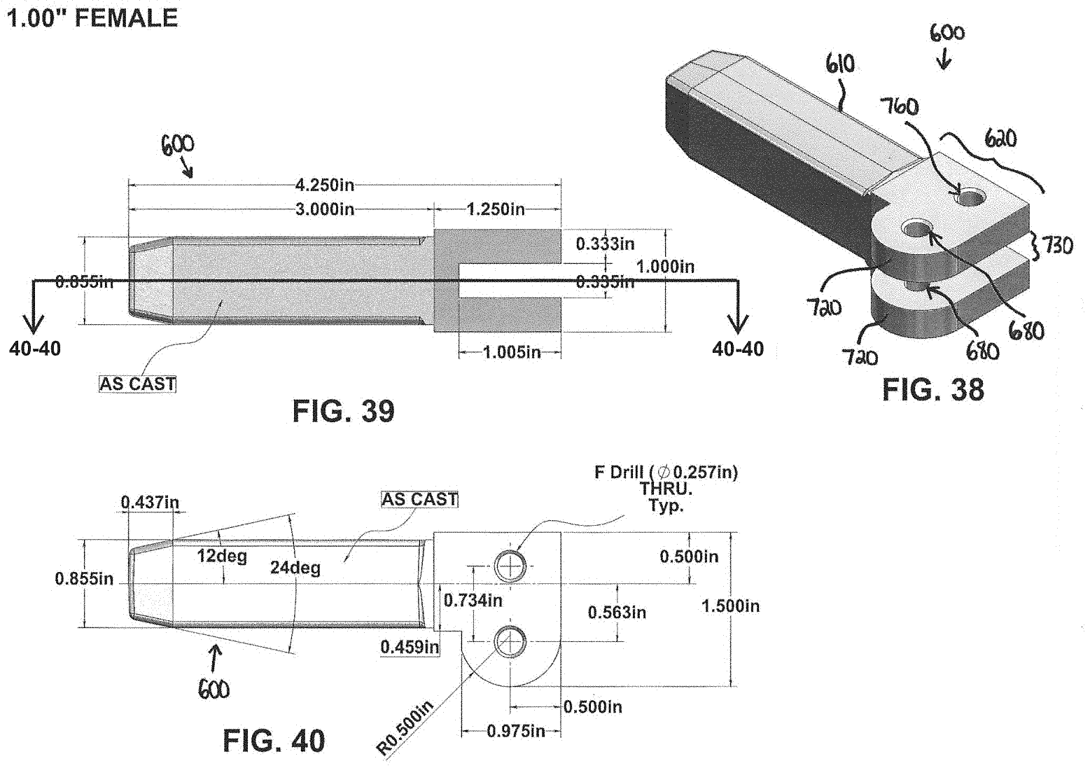

FIG. 38 is a perspective view of the female hinge member 600 in accordance with aspects of the present disclosure.

FIG. 39 is a front plan view of the female hinge member 600 in accordance with aspects of the present disclosure.

FIG. 40 is a cross-sectional view of the female hinge member 600 in accordance with aspects of the present disclosure, taken along line 40-40 of FIG. 39.

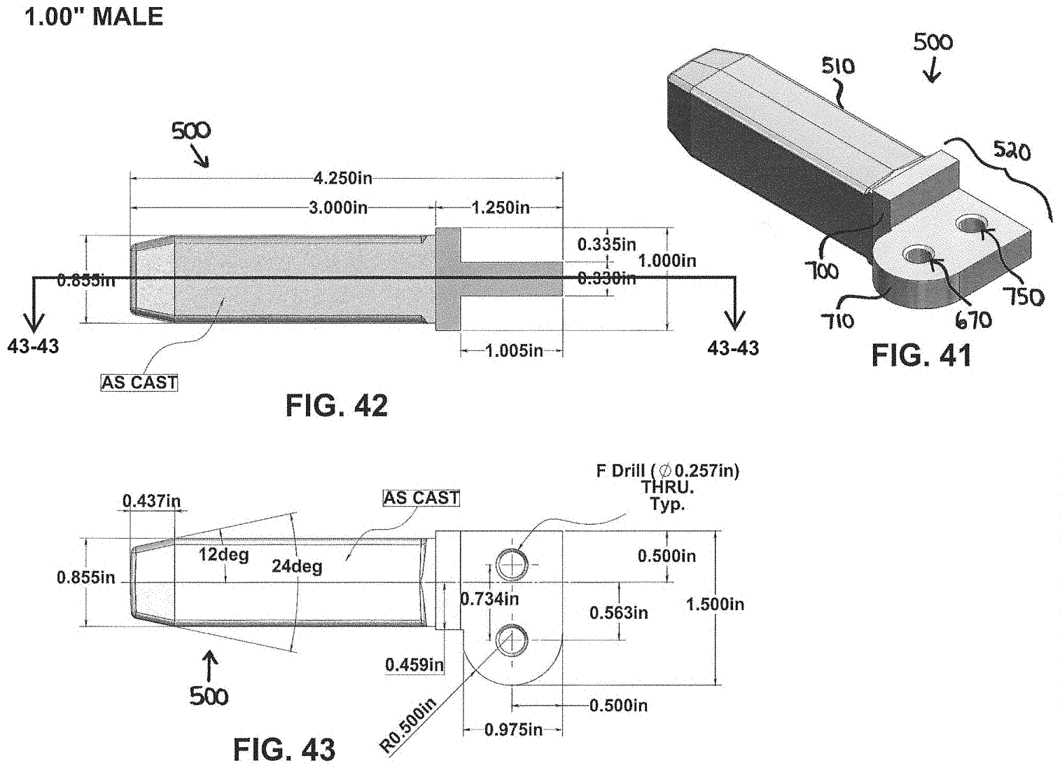

FIG. 41 is a perspective view of the male hinge member 500 in accordance with aspects of the present disclosure.

FIG. 42 is a front plan view of the male hinge member 500 in accordance with aspects of the present disclosure.

FIG. 43 is a cross-sectional view of the male hinge member 500 in accordance with aspects of the present disclosure, taken along line 43-43 of FIG. 42.

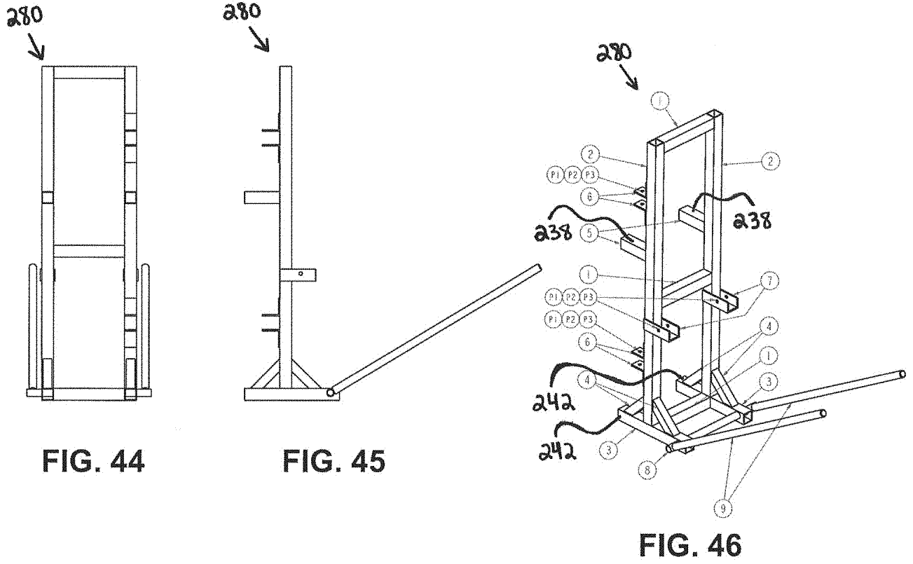

FIG. 44 is a rear plan view of the platform carriage 280 in accordance with aspects of the present disclosure.

FIG. 45 is a left-side plan view of the platform carriage 280 in accordance with aspects of the present disclosure.

FIG. 46 is a top/ladder-front perspective view of the platform carriage 280 in accordance with aspects of the present disclosure.

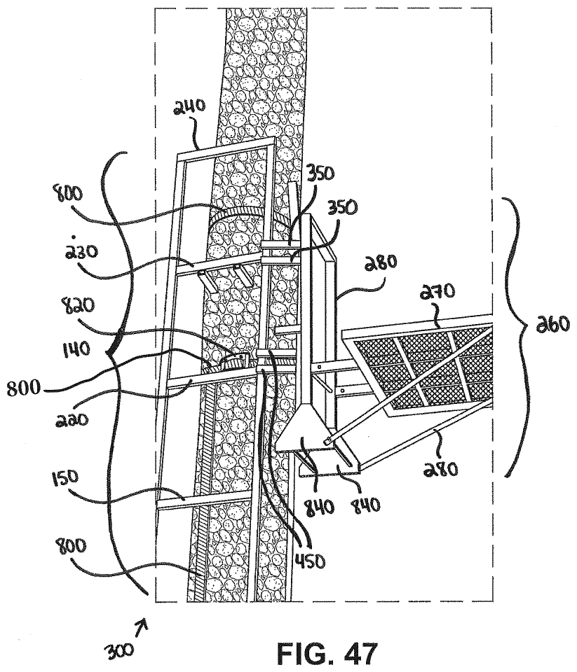

FIG. 47 is a perspective view of the top ladder section 140 and the rest 260 of the right-mounted foldable ladder tree stand 300 (set up on a tree) in accordance with aspects of the present disclosure. In some embodiments, the rest 260 may be equipped with the chain(s), rope(s), or other strap(s) 800 made of any suitable material(s) and/or one or more buckles 820 for tightening the chain(s), rope(s), or other strap(s) 800 around a tree trunk to secure or help secure the rest 260 to the tree trunk. In some embodiments, the platform carriage 280 may include a pair of generally triangular lateral base plates 840.

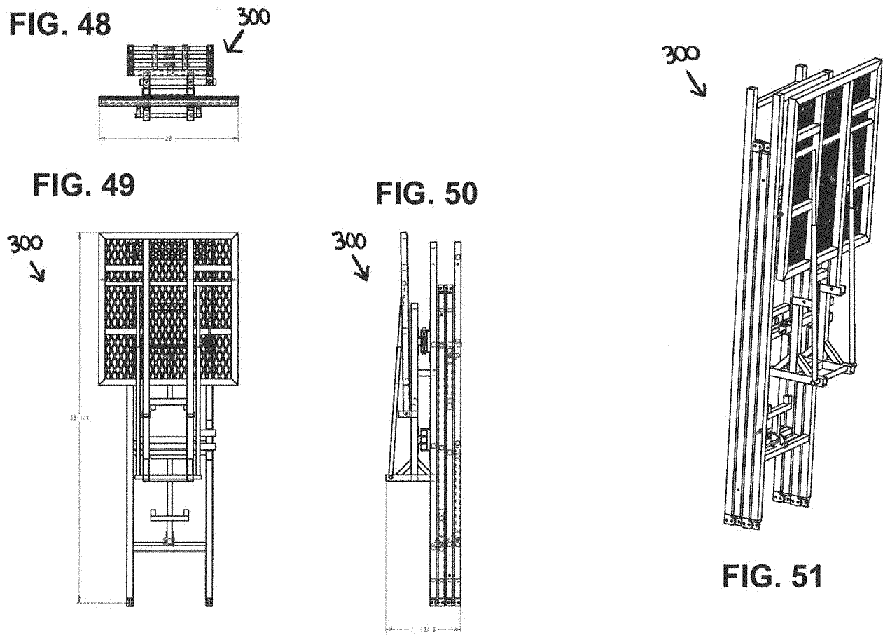

FIG. 48 is a top plan view of the right-mounted foldable ladder tree stand 300 (folded or closed up) in accordance with aspects of the present disclosure.

FIG. 49 is a front plan view of the right-mounted foldable ladder tree stand 300 (folded or closed up) in accordance with aspects of the present disclosure.

FIG. 50 is a left-side plan view of the right-mounted foldable ladder tree stand 300 (folded or closed up) in accordance with aspects of the present disclosure.

FIG. 51 is a perspective view of the right-mounted foldable ladder tree stand 300 (folded or closed up) in accordance with aspects of the present disclosure.

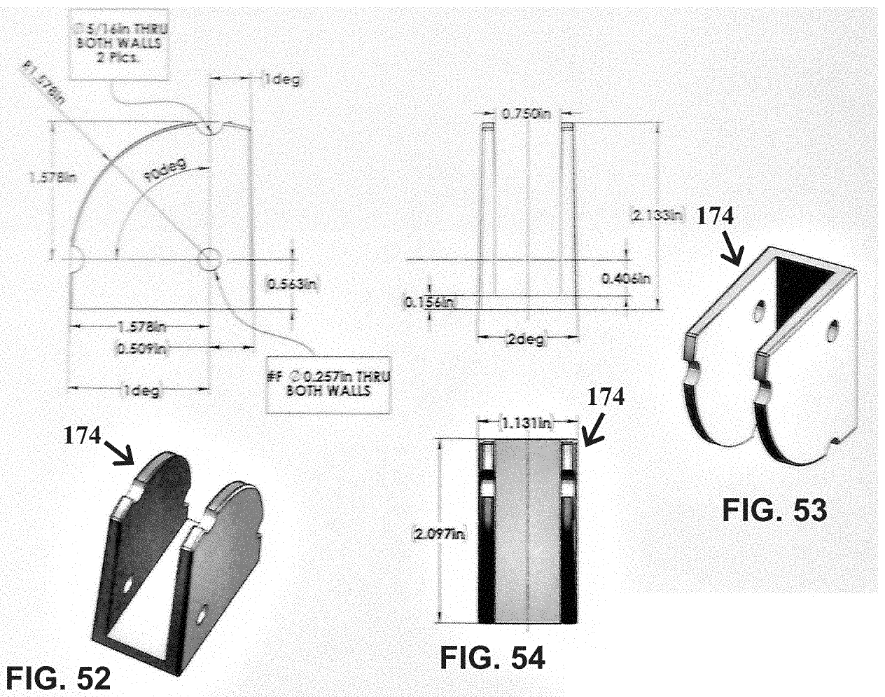

FIG. 52 is a top perspective view of one of the support arm brackets 174 in accordance with aspects of the present disclosure.

FIG. 53 is a bottom perspective view of one of the support arm brackets 174 in accordance with aspects of the present disclosure.

FIG. 54 is a top plan view of one of the support arm brackets 174 in accordance with aspects of the present disclosure.

To set the tree stand 100 (or the tree stand 300) up on a tree, a user removes each retention pin 770 from the respective apertures 760 and aperture 750 and then pivots the side rails 144 to open the hinges 250. The user then reinstalls each retention pin 770 back into/through the respective apertures 760 and aperture 750. Next, the user pivots each of the support arm 170, support arm 190, and support arm 210 relative to each one of the respective side rails 144 to fold out or extend each of the support arm 170, support arm 190, and support arm 210. Next, the user leans the support arms (170, 190, 210) against a trunk of the tree (such that the bottom ladder section 110 is substantially somewhat spaced apart from the tree trunk, the lower middle ladder section 120 is substantially somewhat less spaced apart from the trunk, and the upper middle ladder section 130 is substantially somewhat even less spaced apart from the trunk) and the user leans the support posts 234 (of the top ladder section 140) against the tree trunk and/or suitably presses or otherwise forces the support posts 234 into the tree trunk. The user then pivots the platform carriage 280 relative to the top ladder section 140 to swing the platform carriage around into desirably close proximity to the tree trunk. Next, the user pivots the platform 270 relative to the platform carriage 280 to unfold or extend the platform 270. Then the user multi-pivotally adjusts—via the pivotal couplings provided by the platform carriage pivot arms (350, 360, 450, 460) and then corresponding joints (370, 380, 390, 470, 480, 490)—the leveling (or conversely, the skewing) of the platform carriage 280 (and, in turn, the leveling or skewing of the platform 270) as desired. The user then abuts the support posts 238 and the support rails 242 (of the platform carriage 280) against the tree trunk and/or suitably presses or otherwise forces the support posts 238 and the support rails 242 into the tree trunk. The user may then stand, sit, or lay on the platform 270. It should be noted that in some embodiments, the pivot joints (370, 380, 390, 470, 480, 490) are constructed to be have sufficient friction to suitably inhibit inadvertent shifting of the platform carriage 280 relative to the top ladder section 140 (yet without so much friction so as to preclude suitably facile multi-pivotal adjustments). With some embodiments, the user may use tools to loosen or tighten one or more of such joints as desired. Also, during or after the manipulation of the platform carriage 280 the user may secure the top ladder section 140 and/or the platform carriage 280 to the tree trunk with the chain(s), rope(s), or other strap(s). To separate/remove the rest 260 from the top ladder section 140, the user removes the bolts that connected the platform carriage pivot arms 350 to the top ladder section 140, and the user removes the bolts that connected the platform carriage pivot arms 450 to the top ladder section 140.

While the inventions have been illustrated and described in detail in the drawings and foregoing description, the same is to be considered as illustrative and not restrictive in character, it being understood that only certain embodiments have been shown and described and that all changes and modifications that come within the spirit of the inventions are desired to be protected.

1. A ladder tree stand, comprising:
a ladder;
a platform carriage multi-pivotably coupled to the ladder, and
a platform movably coupled to the platform carriage.

2. The ladder tree stand of claim 1, wherein the platform carriage is multi-pivotally coupled to the ladder.

3. The ladder tree stand of claim 2, further comprising a plurality of pivot arms coupling the platform carriage to the ladder.

4. The ladder tree stand of claim 3, further comprising six pivot joints coupling the platform carriage to the ladder.

5. The ladder tree stand of claim 4, wherein less than seven pivot joints couple the platform carriage to the ladder.

6. The ladder tree stand of claim 5, wherein the platform carriage is configured to be detachable from the ladder, wherein the platform carriage is configured to be attachable to a first side of the ladder, and wherein the platform carriage is configured to be separately attachable to a second side of the ladder.

7. The ladder tree stand of claim 6, wherein the ladder is foldable.

8. The ladder tree stand of claim 7, wherein the ladder comprises a first runged section, wherein the ladder comprises a second runged section, and wherein the ladder comprises a hinge pivotally coupling the first runged section to the second runged section.

9. The ladder tree stand of claim 8, wherein the hinge comprises a first post, wherein the hinge comprises a male hinge node extending from the first post, wherein the hinge comprises a second post, wherein the hinge comprises a female hinge node extending from the second post, wherein the male hinge node and the female hinge node are configured to mate together, wherein the male hinge node and the female hinge node are configured to cooperate to pivot relative to each other about a first axis, wherein the male hinge node and the female hinge node are configured to cooperate to prevent substantial rotation of the first post relative to the second post about a second axis, and wherein the male hinge node and the female hinge node are configured to cooperate to limit a pivotal range of motion between the first post and the second post.

10. A ladder tree stand for using a tree to perch above a ground level, the ladder tree stand comprising:
a rest;
a means for elevating the rest above the ground level; and
a means for adjustably positioning the rest relative to the means for elevating the rest.

11. A hinge, comprising:
a first post;
a male hinge node extending from the first post;
a second post; and
a female hinge node extending from the second post;
wherein the male hinge node and the female hinge node are configured to mate together,
wherein the male hinge node and the female hinge node are configured to cooperate to pivot relative to each other about a first axis,
wherein the male hinge node and the female hinge node are configured to cooperate to prevent substantial rotation of the first post relative to the second post about a second axis, and
wherein the male hinge node and the female hinge node are configured to cooperate to limit a pivotal range of motion between the first post and the second post.

12. The hinge of claim 11, comprising:
an axle extending through the male hinge node and extending through the female hinge node.

13. The hinge of claim 12, wherein the axle comprises a bolt.

14. The hinge of claim 12, wherein the male hinge node comprises a stop, wherein the male hinge node comprises a first protuberance extending from the stop, wherein the first protuberance defines a first aperture extending therethrough, wherein the female hinge node comprises a second protuberance, wherein the female hinge node comprises a third protuberance spaced apart from the second protuberance so as to define a slot therebetween, wherein the second protuberance defines a second aperture extending therethrough, wherein the third protuberance defines a third aperture extending therethrough, wherein the first protuberance extends into the slot, wherein the axle extends through the second aperture, wherein the axle extends through the first aperture, and wherein the axle extends through the third aperture.

15. The hinge of claim 14, wherein the stop comprises a generally rectilinear flange.

16. The hinge of claim 14, wherein the first protuberance defines a fourth aperture extending therethrough, wherein the second protuberance defines a fifth aperture extending therethrough, and wherein the third protuberance defines a sixth aperture extending therethrough.

17. The hinge of claim 16, comprising:
a shaft extending through the fifth aperture, extending through the fourth aperture, and extending through the sixth aperture.

18. The hinge of claim 17, wherein the shaft comprises a spring-loaded pin.

19. The hinge of claim 18, wherein the first post is substantially rectilinear.

20. The hinge of claim 19, wherein the second post is substantially rectilinear.

21. A foldable ladder, comprising:
a first runged section;
a second runged section; and
a hinge pivotally coupling the first runged section to the second runged section,
wherein the hinge comprises a first post,
wherein the hinge comprises a male hinge node extending from the first post,
wherein the hinge comprises a second post,
wherein the hinge comprises a female hinge node extending from the second post,
wherein the male hinge node and the female hinge node are configured to mate together,
wherein the male hinge node and the female hinge node are configured to cooperate to pivot relative to each other about a first axis,
wherein the male hinge node and the female hinge node are configured to cooperate to prevent substantial rotation of the first post relative to the second post about a second axis, and
wherein the male hinge node and the female hinge node are configured to cooperate to limit a pivotal range of motion between the first post and the second post.
